(19) United States
(12) Patent Application Publication
(10) Pub. No.: US 2009/0055228 A1
(43) Pub. Date: Feb. 26, 2009

(54) SYSTEM AND METHOD FOR DUSPLAYING INHERENT PROJECT UNCERTAINTY

(76) Inventors: Bruce P. Henry, Seattle, WA (US); Jason Carlson, Seattle, WA (US); Charles A. Seybold, Sammamish, WA (US); Bryan Wilkerson, Seattle, WA (US)

Correspondence Address: PERKINS COIE LLP;PATENT-SEA, P.O. BOX 1247, SEATTLE, WA, 98111-1247, US

(21) Appl. No.: 11/844,228

(22) Filed: Aug. 23, 2007

(51) Int. Cl. G06Q 10/00

(52) U.S. Cl. 705/7

(57) ABSTRACT

A software and/or hardware facility for graphically displaying schedule uncertainty inherent in projects. In some embodiments, the facility generates uncertainty bars for display to users that express the uncertainty inherent in work items, such as projects and/or tasks. An uncertainty bar can visually indicate the work item's earliest start date, earliest expected finish date, expected finish date, latest expected finish date and latest finish date, as calculated by the facility. For a project that has multiple component tasks, the facility can generate an uncertainty bar for each component task. The facility can also generate an uncertainty bar for the entire project. In some embodiments, the facility generates graphs that display the history of uncertainty for work items.

### CROSS-REFERENCE TO RELATED APPLICATION

This application is related to co-pending U.S. patent application Ser. No. 11/844,219 (entitled SYSTEM AND METHOD FOR MANAGING INHERENT PROJECT UNCERTAINTY, Attorney Docket No. 63863.8001.US00), filed concurrently herewith and incorporated herein in its entirety by reference.

### BACKGROUND

In personal and professional life, a project can range in size from the very small (e.g., a single person project) to the very large (e.g., a project involving hundreds of individuals or organizations). In order to ensure that projects are completed in a timely fashion, it is increasingly common for individuals and organizations to use project management software to manage projects, especially large ones.

One of the primary functions of existing project management software is to estimate a project's completion date and track progress against milestones. The prevalent method involves decomposing a project into smaller tasks (often referred to as a work breakdown structure or WBS). For each task in the WBS, a user specifies one of the following: (1) a start date and an end date, (2) the total effort required to complete the task, or (3) the total duration of the task. Tasks can be made dependent (i.e., one task cannot be started until another task is completed) or independent (i.e., two tasks can be worked on concurrently). One or more individuals is assigned to each task. A schedule for each task is determined based on the time required to complete the task and the task's dependencies. Project management software then determines a schedule, which can be visually displayed, for the entire project based on the schedules of its component tasks. In essence, existing project management software employs user-provided inputs regarding component tasks to determine the completion date of the entire project.

There are several flaws with the techniques used by existing project management software, however. A first flaw is that existing techniques rarely determine with any accuracy the completion date of a project. In order to determine a project's completion date, existing techniques assume that each component task's start date and end date is certain. For example, FIGS. 1A and 1B depict graphs 100 and 150 that illustrate task effort and schedule calculation in accordance with existing project management techniques. In FIG. 1A, a project P is composed of two tasks T₁ and T₂. A first task T₁ has a total effort of five days, as represented by bar 105. A second task T₂ is dependent upon task T₁ and has a total effort of three days, as represented by bar 110. Existing project management techniques determine with 100% certainty that the completion date of project P is after eight days, i.e., after the sequential completion date of tasks T₁ and T₂, as represented by bar 115 In FIG. 1B, tasks T₁ and T₂, represented by bars 155 and 160 respectively, are independent tasks that both have a total effort of five days. The completion date of project P is thus after five days as represented by bar 165, i.e., the latest completion date of either of tasks T₁ or T₂. While project planning in accordance with the techniques depicted in FIGS. 1A and 1B makes intuitive sense, in the real world schedules typically slide. For example, the techniques depicted in FIGS. 1A and 1B fail to account for inherent uncertainty as to the start and completion dates of tasks. Because existing techniques fail to account for this inherent uncertainty, they cannot determine with meaningful accuracy a project's completion date. Therefore, any visually displayed schedule that is determined by existing techniques will generally not accurately depict a project's completion date or the completion dates of its component tasks.

A second flaw with the techniques employed by existing project management software is that it can be difficult to obtain status updates from individuals and/or organizations involved in a project. In the absence of updates, project plans produced by existing project management software become more and more inaccurate over time.

Accordingly, there is a need for project management systems and methods that are not susceptible to the aforementioned problems.

### BRIEF DESCRIPTION OF THE DRAWINGS

FIGS. 1A and 1B illustrate task effort and project schedule determination in accordance with prior art techniques.

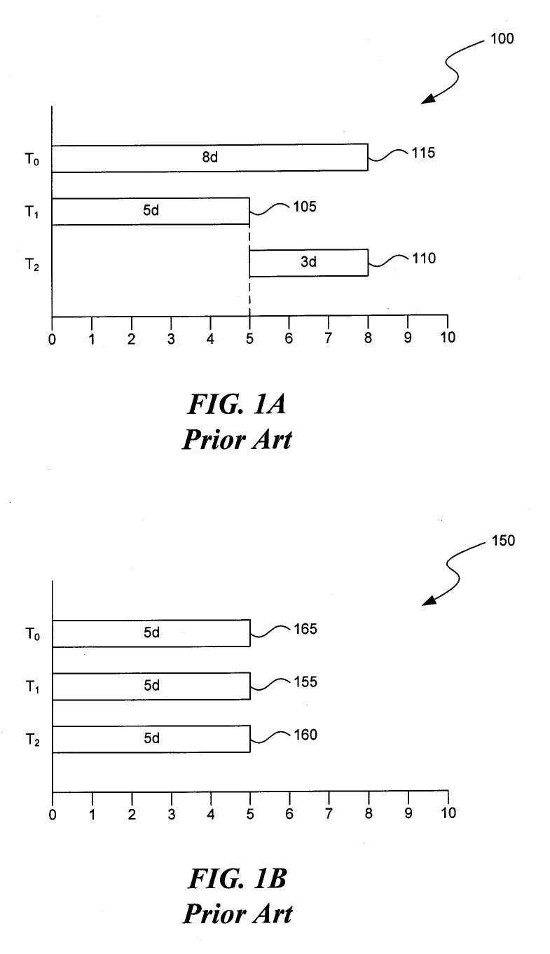

FIG. 2 is a block diagram that illustrates components of a project management facility.

FIGS. 3A-3D depict uncertainty bars that visually display the inherent uncertainty in work items.

FIG. 4 is a block diagram of the use of uncertainty bars to visually depict a project and the relationship of its component tasks.

FIGS. 5A and 5B are graphs that illustrate the history of inherent uncertainty in a work item.

FIG. 6 is a graph that illustrates the history of inherent uncertainty in a work item.

FIG. 7 is a graph illustrating the history of inherent uncertainty and predicted finish of a work item.

FIG. 8 is a graph that illustrates uncertainty bars for a project and its component tasks in effort space.

### DETAILED DESCRIPTION

A software and/or hardware facility for graphically displaying schedule uncertainty inherent in projects is disclosed. In some embodiments, the facility generates uncertainty bars for display to users that express the uncertainty inherent in work items, such as projects and/or tasks. An uncertainty bar can visually indicate the work item's earliest start date, earliest expected finish date, expected finish date, latest expected finish date and latest finish date, as calculated by the facility. For a project that has multiple component tasks, the facility can generate an uncertainty bar for each component task. The facility can also generate an uncertainty bar for the entire project. The facility can thus visually display the uncertainty inherent in projects to users in a manner that allows users to quickly interpret and manage projects.

In some embodiments, the facility generates graphs that display the history of uncertainty for work items. The facility can generate graphs that display the history of inherent uncertainty for completed work items as well as for work items currently in progress. In some embodiments, the facility can generate visual indications of the predicted future of uncertainty for work items. The facility can thus visually display how the uncertainty of work items changes over time and how the uncertainty is predicted to change.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

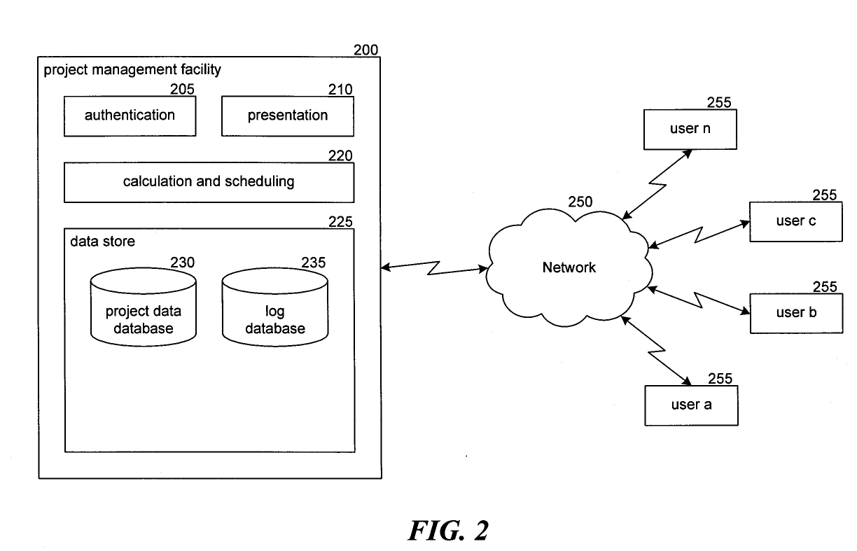

FIG. 2 is a block diagram illustrating components of a project management facility 200 (“the facility”). Users 255 interact with the facility via a network 250, such as the Internet. Users may be actual human users, such as members of a project or organization, computer programs, or other entities. The facility has various components to allow users to manage projects. These components include an authentication component 205, a presentation component 210, a calculation and scheduling component 220 and a data store 225. The authentication component 205 authenticates the user 255 and grants the user 255 access to the facility. The presentation component 210 presents a user interface to the user 255 and receives user requests and responses. The calculation and scheduling component 220 performs statistical calculations to predict likely completion dates for project tasks and projects and calculate likely project schedules. The facility can include other components that perform other functions. The various components of the facility can retrieve and store data related to their functioning in the data store 225, which includes a project data database 230 and a log database 235.

The project management facility allows users to specify an uncertainty associated with the completion of work items. For example, a user may specify that a particular work item may take 3 to 6 days to complete. Allowing users to specify such uncertainty reflects the real-life challenge of predicting workflow and managing projects. Work items and their inherent uncertainty are described in the previously-referenced co-pending patent application. Work items include projects, which represent effort by zero or more users to accomplish a particular result. Work items can also include tasks, which represent a task, job or assignment by zero or more users that comprise a portion of a project. Work items can also include containers, which represent logical groupings or collections of zero or more tasks and/or other containers in a project. A work item can have associated with it an estimate provided by a user, such as a ranged estimate of the amount of work remaining before the work item is completed. An estimate can also be an estimate of the percentage of work remaining, the effort remaining, the estimated cost, the estimated completion date, and/or other types of estimates. Based at least in part on the provided estimate, the facility can calculate five dates associated with the work item: an earliest start date, an earliest expected finish date, an expected finish date, a latest expected finish date and a latest finish date. The facility can calculate the five dates in accordance with values predicted by a statistical model, such as a normal distribution. The facility can calculate these five dates to account for the uncertainty inherent in the work item as to its start and finish dates. A method of calculating the five dates may be found in the previously-referenced co-pending patent application.

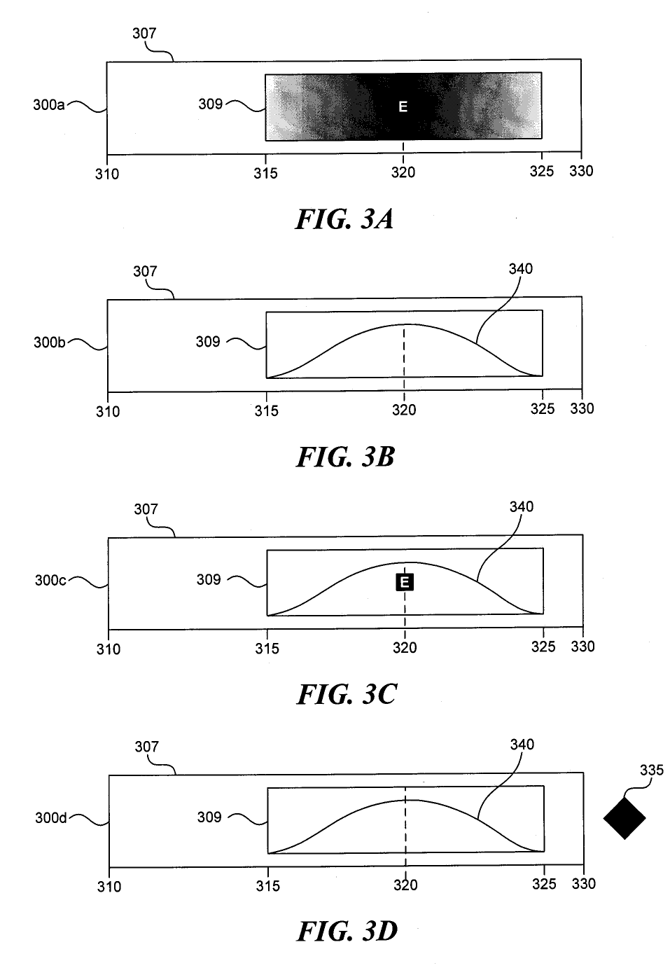

If a user has specified uncertainty associated with particular work items, the project management facility uses a variety of techniques to graphically depict the uncertainty to users in a manner that facilitates project management. FIGS. 3A-3D depict four different types of uncertainty bars, or u-bars 300a, 300b, 300c, and 300d, that may be used by the facility to visually display the inherent uncertainty in work items. Each u-bar is associated with a work item. The facility can display a u-bar on a schedule, calendar, or other timeline to indicate the amount of remaining time required to complete the work item associated with the u-bar. The facility can also display a u-bar in effort space (e.g., showing the amount of effort required in person-days) to indicate the amount of remaining effort required to complete the work item associated with the u-bar. Each u-bar has an outer bar 307 and an inner bar 309. Each u-bar also has five points that each represent a date calculated by the facility. The first point 310 is located at the left-most position of the outer bar 307 and represents the work item's earliest start date. The second point 315 is located at the left-most position of the inner bar 309 and represents the work item's earliest expected finish date. The third point 320 is located at an intermediate section of the inner bar 309 and represents the work item's expected finish date, or most likely or probable finish date. The fourth point 325 is located at the right-most position of the inner bar 309 and represents the work item's latest expected finish date. The fifth point 330 is located at the right-most position of the outer bar 307 and represents the work item's latest finish date. The use of an inner bar and an outer bar in the u-bar therefore quickly conveys a significant amount of timing information to the user about the expected finish date of the work item, as well as the uncertainty inherent in that expected finish date.

When managing performance of a particular work item, a user will typically be interested in the expected finish date associated with the work item since it reflects the most likely point at which the work item will be completed. The expected finish date is highlighted by the facility in various different ways in u-bars 300a, 300b, 300c and 300d. In the u-bar 300a depicted in FIG. 3A, the inner bar 309 of the u-bar has a letter E (for “Expected”) located at the third point 320. By placing the letter E at the third point 320, the facility visually expresses that the point represents the calculated expected finish date. To further reinforce this notion, inner bar 309 also contains a color gradation, or graduated shading, with the color or shading darkest at the third point 320 and becoming progressively lighter towards points 315 and 325 at the extremities of inner bar 309. In some embodiments, the facility can display the calculated expected finish date in other ways, such as by using different alphabetical, numerical and/or other symbols or icons at point 320 and/or by using different shading, hatching, highlighting and/or coloring within inner bar 309.

FIG. 3B depicts an alternate technique for visually expressing the uncertainty of a work item in a u-bar. The inner bar 309 of u-bar 300b contains a curve 340. As described in the previously-referenced co-pending patent application, a probability density function may be used by the facility to estimate the expected finish dates of the associated work item. The curve 340 represents a graphical portrayal of the probability density function associated with the work item. The peak of the curve 340, located at point 320, represents the expected finish date calculated by the facility for the associated work item. Other points on the curve 340 represent less likely or less probable finish dates for the associated work item, with the height of the curve corresponding to the probability density at each point.

The u-bar 300c in FIG. 3C is identical to the u-bar 300b of FIG. 3B with an additional element, a letter E located at third point 320. Curve 340 is located in inner bar 309 and represents the probability density function associated with the work item of which the uncertainty is represented by the u-bar 300c. As in FIG. 3A, the letter E located at the third point 320 visually expresses that the third point represents the calculated expected finish date. As previously described, the facility can use alphabetical, numerical and/or other symbols or icons other than the letter E at point 320 to indicate the calculated expected finish date.

The u-bar 300d in FIG. 3D is identical to the u-bar 300b of FIG. 3B. FIG. 3D also depicts a marker 335, however, shown as a diamond icon. The marker 335 represents a promise date for the work item associated with u-bar 300d. A promise date is a date by which a user or users associated with the work item has promised or agreed that the work item will be completed. The promise date is defined by a user or users, and has no correlation with the expected finish dates calculated by the facility for a work item. The position of the promise date with respect to the u-bar provides information to a project manager about the likelihood that the promise date will be met. For example, as shown in FIG. 3D, the position of the marker 335 to the right of the u-bar 300d indicates that the latest expected finish date is prior to the promise date. Because the promise date falls after the latest expected finish date, the work item associated with u-bar 300d is likely to be completed by the promise date. Rather than a diamond icon, the facility can also use other markers or visual indications to visually express a work item's promise date.

In FIGS. 3B-3D, the curves 340 resemble bell curves that are centered in the middle of the inner bars 309. A bell curve represents a normal distribution, which is uni-modal, often used by the facility to calculate the probabilities of expected start and finish dates for the associated work item. In some embodiments, the facility can use distributions other than the normal distribution to calculate the locations of the various data points. For example, the facility can use a beta distribution or a log-normal distribution to calculate the probabilities of expected start and finish dates. The facility can also use distributions that do not resemble a standard bell curve, are bi-modal instead of uni-modal, and/or have other characteristics. The facility can also use different distributions for different work items. For example, the facility can use the normal distribution for one work item and the beta distribution for another work item to calculate the probabilities of the work items being completed at a particular point in time. As another example, the facility can use a distribution for which the curve of its probability density function is asymmetrical about its mean or median. In such an embodiment, the curve 340 would be asymmetrically offset from the center of the inner bar 309. The facility can also use distributions for which the curves of the probability density functions have multiple peaks, infection points and/or otherwise express a departure from a normal distribution.

The u-bars 300 illustrated in FIGS. 3A-3D visually express the uncertainty inherent in the associated work items, which can be tasks, containers, and/or projects. One advantage of the u-bars 300 is that a user, such as a project manager or other user, can quickly and easily see the work item's calculated expected start and finish dates as well as derive an understanding of the probabilities or likelihoods of the work item being started and completed at certain dates. This can allow project managers and/or other users to better manage work items toward a successful and timely completion.

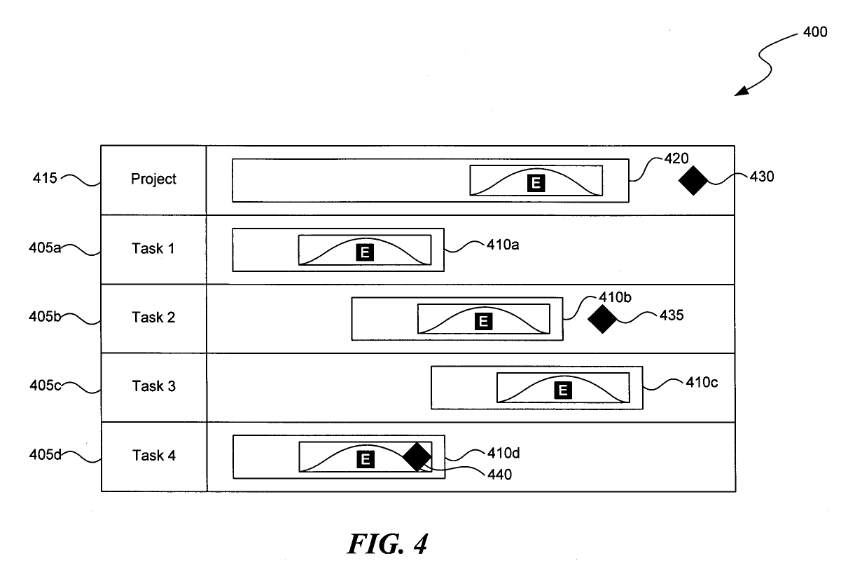

FIG. 4 depicts u-bars generated by the facility and used to depict a project 415 and its component tasks. Project 415 contains four tasks 405a, 405b, 405c and 405d. The project 415 has an associated u-bar 420 reflective of the timing of the entire project. Each task in the project also has an associated u-bar 410a, 410b, 410c and 410d, reflective of the timing of the particular task. As described in the previously-referenced co-pending patent application, the facility generates the u-bar 420 of the project 415 based at least in part upon the calculated expected start and finish dates for each of the tasks 405a, 405b, 405c and 405d. As previously described with respect to FIGS. 3A-3D, each of the u-bars 410a, 410b, 410c and 410d and 420 graphically represents five points that correspond to the five dates calculated by the facility: the earliest start date, the earliest expected finish date, the expected finish date, the latest expected finish date and the latest finish date.

Project 415 and tasks 405b and 405d have promise dates, as indicated by the markers 430, 435, and 440, respectively. The position of marker 435 indicates that the task 405b is likely to be completed before its promise date. In contrast, the position of marker 440 within the u-bar 410d indicates that there is a significant likelihood or probability that the task 405d will not be completed by its promise date. By graphically highlighting such risk, the facility allows a project manager and/or other user to take proactive steps to ensure that task 405d is completed by its promise date, such as by allocating or reallocating more resources to task 405d. For the project 415, the position of marker 430 outside of its u-bar 420 indicates that project 415 as a whole is likely to be completed by its promise date.

The u-bar 420 for project 415 visually expresses the uncertainty inherent in the expected finish date of the project. Such uncertainty in the project 415 is at least partly attributable to the uncertainty inherent in its component tasks 405a-405d. The graphical display produced by the user allows a project manager and/or other user to quickly and easily ascertain the calculated expected start and finish dates of the project 415 and thus gain an understanding of the probability or likelihood of the project being completed on time. As previously noted, existing techniques for the display of project and task schedules are based on assumptions that projects and tasks have certain start and finish dates. The project manager and/or other user of existing techniques is therefore forced to supplement displayed existing schedules with their own experience and understanding of the uncertainty inherent in projects and tasks. In contrast, the embodiments illustrated in FIGS. 3A-3D and FIG. 4 visually depict this heretofore undisplayed uncertainty with particular clarity.

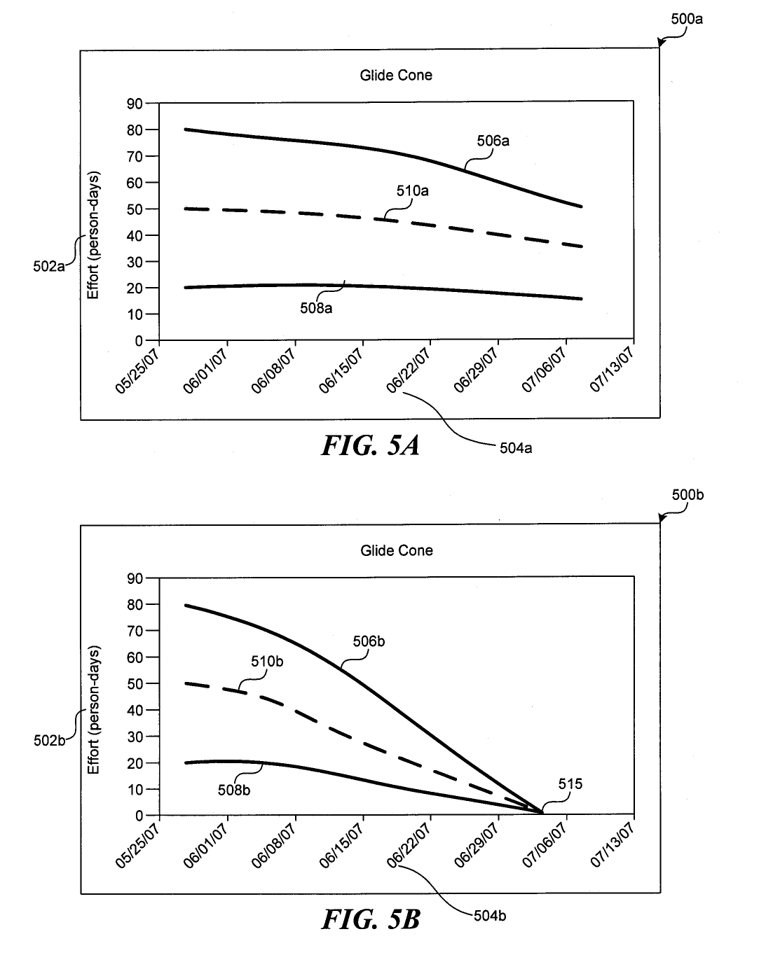

FIGS. 5A and 5B are graphs generated by the facility that illustrate the history of inherent uncertainty in work items. FIG. 5A depicts a graph 500a, hereinafter referred to as a “glide cone,” that displays the history of uncertainty for a work item, such as a project or a task, that is currently in progress. The y-axis 502a of the graph is the effort remaining for the work item, shown using a scale of person-days. The x-axis 504a of the graph is time, with the units of time being weekly intervals. In graph 500a, an upper line 506a represents a high estimate of remaining effort, a lower line 508a represents a low estimate of remaining effort, and a dashed line 510a represents the most likely remaining effort for the work item. Each of the lines 506a, 508a and 510a generally trend downwards over time, which indicates that the remaining effort (high estimate, low estimate and most likely) generally trends downward over time. The gradual narrowing of the vertical distance between the upper line 506a and the lower line 508a indicates that the uncertainty regarding the effort remaining for the work item decreases over time. That is, as the work item moves toward completion, the uncertainty regarding the amount of work or effort yet to be performed decreases. By generating graphs in this form, the facility can thus visually inform a project manager and/or other user of the uncertainty over time of the work item.

FIG. 5B is another glide cone graph 500b that displays the history of uncertainty for a work item, such as a project or a task, that has been completed. As in FIG. 5A, the y-axis 502b of graph 500b is the effort remaining for the work item and is shown using a scale of person-days, and the x-axis 504b is time, with the units of time being weekly intervals. In the graph 500b, an upper line 506b represents a high estimate of remaining effort; a lower line 508b represents a low estimate of remaining effort; and a dashed line 510b represents the most likely remaining effort for the work item being graphed. Graph 500b illustrates how, for a completed work item, the lines 506b, 508b and 510b indicating remaining effort (high estimate, low estimate and most likely) generally trend downward over time and converge at a point 515 on the x-axis 504b between the dates Jun. 29, 2007 and Jul. 6, 2007. It can thus be seen that the uncertainty regarding the remaining effort for this work item gradually diminished over time until it reached zero at point 515. Point 515 represents the actual finish date of the work item. The facility can thus visually inform a project manager and/or other user how the uncertainty of the work item changed over time as the work item was moved towards completion.

Although the glide cone graphs 500a and 500b depict uncertainty over particular periods of time using weekly intervals, other intervals of time (e.g., seconds, minutes, hours, days, months, years, etc.) are of course possible. The facility can generate glide cone graphs over any period of time in the history of a work item, from its start to its finish. The facility can also allow a user to move backwards and forward in time to examine the progression over time of the work item's uncertainty. The facility can also display other visual indications, such as information tickers or windows, that provide additional information about the status of the work item at various points in time.

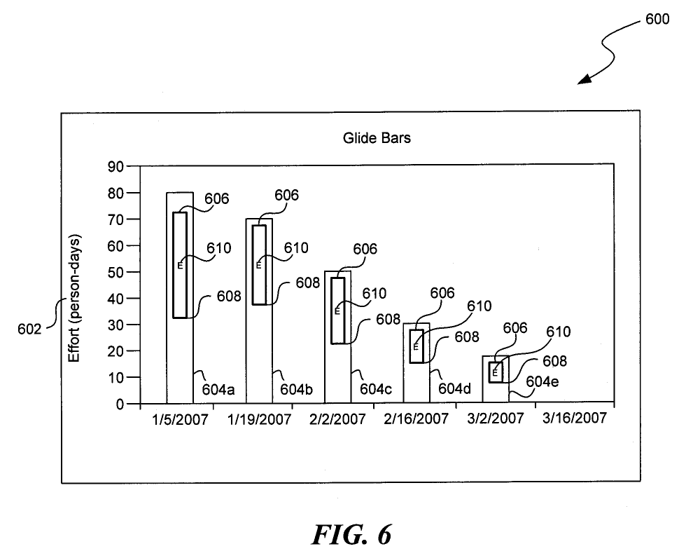

FIG. 6 is an alternate form of a graph that illustrates the history of inherent uncertainty in a work item. In FIG. 6, a bar graph 600 (referred to as a “glide bar” graph), displays the history of uncertainty for a work item, such as a project or a task. The y-axis 602 of the glide bar graph 600 is the effort remaining for the work item and is shown as person-days. The x-axis 604 of the glide bar graph 600 is time, with the units of time being bi-weekly intervals, although other intervals of time are of course possible. The facility generates glide bars 604a, 604b, . . . 604e to represent the uncertainty regarding the effort remaining for the work item at a particular point in time. Each glide bar 604 has three points that represents the uncertainty regarding the effort remaining for the work item. Points 606 represent a high estimate of remaining effort. Points 608 represent a low estimate of remaining effort. Points 610 represent the most likely remaining effort, as indicated by the letter “E.” It can be seen that the height of the glide bars 604a, 604b, . . . 604e decreased over time, which indicates that the uncertainty regarding the remaining effort (high estimate, low estimate and most likely) for the work item gradually diminished over time, until it reached zero at the completion of the work item. In some embodiments, the facility can generate and display a new glide bar for the glide bar graph each time the remaining effort for the work item is updated (e.g., when a project manager and/or other user provides a new estimate regarding the remaining effort for the work item). In some embodiments, if new estimates for the work item are not provided, the facility can generate and display a new glide bar on a periodic or ad hoc basis and make assumptions regarding how much work remains to be done. Although the graph 600 depicts uncertainty over a particular period of time (i.e., from Jan. 5, 2007 to Mar. 16, 2007), the facility can generate graphs over any period of time in the history of the work item. The facility can also allow a user to move backwards and forward in time to examine the uncertainty over various periods in time. The facility can thus visually inform a project manager and/or other user via the glide bar graph 600 how the uncertainty regarding the remaining effort of the work item changed over time as the work item was moved towards completion.

Although the glide cones and glide bar graph illustrated in FIGS. 5A, 5B and 6 depict uncertainty as to the remaining effort for a work item, the facility can generate glide cone and/or glide bar graphs that depict uncertainty for work items in other ways. For example, the facility can require users to provide estimates as to the cost of a work item or the amount of money required to complete the work item. The facility can then graph the historical progression of uncertainty as to the cost or amount of money required to complete the work item. As another example, the facility can require users to provide an estimated finish date for a work item. The facility can then graph the historical progression of uncertainty as to the estimated finish date. The facility can also generate glide cone and/or glide bar graphs that depict uncertainty for work items using other calculated metrics.

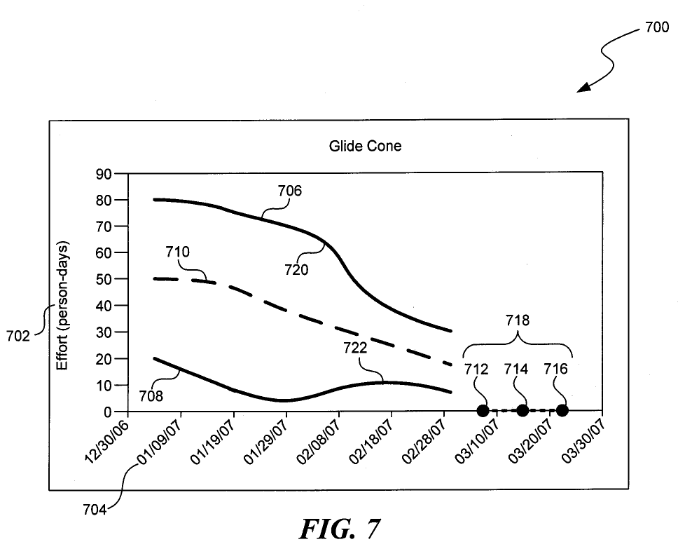

FIG. 7 is a glide cone graph that depicts both the history as well as the predicted future of inherent uncertainty for a work item. Similar to the glide cones depicted in FIGS. 5A and 5B, the y-axis 702 is the effort remaining for the work item and is shown as person-days, and the x-axis 704 is time. The line 706 represents the high estimate of remaining effort, the lower line 708 represents the low estimate of remaining effort, and dashed line 710 represents the most likely remaining effort for the work item. In the depicted example, the line 706 has an inflection point located approximately at point 720, at which point the slope of line 706 decreases. The change in the slope of line 706 indicates an improvement in the estimate of the uncertainty regarding the remaining effort for the work item. Such a change can occur if, for example, progress on the work item increased and it became easier to scope the remaining effort. Conversely, if progress on the work item slows, the facility may generate a graph in which the slope of the line 706 line increases. Line 708, representing the low estimate of remaining effort, has an inflection point located approximately at point 722, at which point the slope of the line decreases. As depicted, the decrease in the slope of line 708 at inflection point 722 indicates that the uncertainty regarding the low remaining effort has increased. Such a change can occur if, for example, if a challenging problem associated with the work item arose and the amount of time expected to overcome the problem was greater than previously anticipated. Changes in the slopes of the lines 706, 708 and 710 can occur for other reasons. For example, the slope of the lines may change significantly if the facility makes assumptions regarding how much work remains to be done for the work item, and a project manager or other user provides an updated estimate regarding the work remaining that is different from the assumptions made by the facility.

The glide cone graph 700 in FIG. 7 also illustrates a feature referred to as the “landing pad.” A landing pad refers to the visual depiction of the calculated expected finish date of a work item, or a range of calculated expected finish dates of the work item. In graph 700, a landing pad 718 is highlighted on the x-axis by a dotted line. The landing pad is bounded by points 712 and 716 on the x-axis. Point 712 represents the calculated earliest finish date for the work item whose uncertainty is being graphed in graph 700 and corresponds to the point at which line 708 is projected to reach the x-axis. Point 716 represents the calculated latest expected finish date for the work item, and corresponds to the point at which line 706 is projected to reach the x-axis. Between points 712 and 716 falls a point 714, which is the most likely expected finish date for the work item. Point 714 corresponds to the point at which line 710 is projected to reach the x-axis. The facility can calculate the locations of the points 712, 714 and 716 by making assumptions about the calculated earliest, most likely and latest expected finish dates for the work item. Alternatively or additionally, the facility can calculate the locations of the points 712, 714 and 716 by extrapolating forward the lines 708, 710 and 706, respectively, using their slopes at their most recent points. One advantage of the landing pad feature is that it allows project managers and/or other users to quickly and easily see the expected finish dates for the work item. This can enable the project managers and/or other users to determine if a project or task is ahead of schedule, on schedule, or behind schedule, and allocate or reallocate resources accordingly. The facility can also allow a user to move backwards and forward in time to examine the how the landing pad changes, or to change assumptions and/or estimates to see how the changes affect the location of the landing pad.

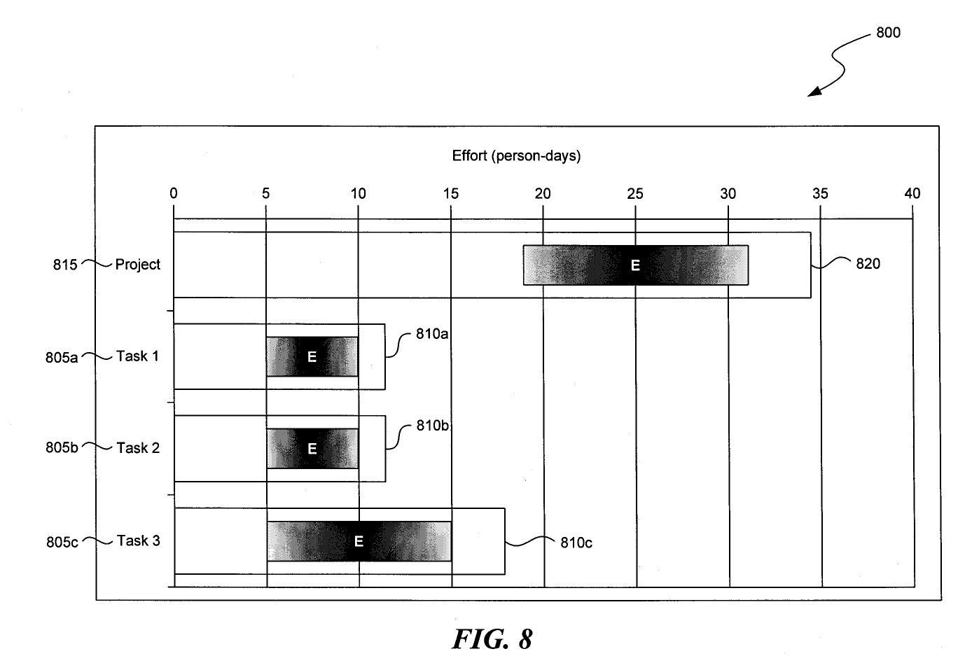

FIG. 8 is a graph 800 that illustrates uncertainty bars for a project and its component tasks in effort space. Project 815 contains three tasks 805a, 805b and 805c. The project 815 has an associated u-bar 820 reflective of the effort (as calculated in person-days) likely required to complete the project. Each task in the project also has an associated u-bar 810a, 810b and 810c, reflective of the effort (also as calculated in person-days) likely required to complete the particular task. As described in the previously-referenced co-pending patent application, the facility generates the u-bar 820 of the project 815 based at least in part upon the calculated effort for each of the tasks 805a, 805b and 805c. Also as previously described in the previously-referenced co-pending patent application, each of the u-bars 810a, 810b, 810c and 820 graphically represents five points that correspond to the origin and four likely amounts of remaining effort calculated by the facility: the expected minimum remaining effort, the expected remaining effort, the maximum expected remaining effort and the maximum remaining effort.

The graph 800 illustrates the uncertainty inherent in the amount of effort required to complete each component task 805a, 805b and 805c and thus the uncertainty inherent in the amount of effort required to complete the project 815. The facility can also generate the graph 800 for individual staff members or users instead of tasks and provide a total for the staff members or users as a whole instead of a project. For example, instead of a u-bar for each of tasks 1-3, the facility can generate a u-bar for each of three staff members that displays the amount of effort required for that staff member to complete all of the tasks assigned to them. The facility can then generate a u-bar for the three staff members that displays the amount of effort required for the three staff members to complete all of their assigned tasks. Such a graph would illustrate the uncertainty inherent in the amount of effort required of each individual staff member to complete their assigned tasks and thus the uncertainty inherent in the amount of effort required to complete all of the tasks assigned to the three individual staff members.

The graphs in FIGS. 3A-8 are shown using a linear scale. However, the facility can use other scales for either or both the x-axis and the y-axis, such as logarithmic scales.

While various embodiments are described in terms of the environment described above, those skilled in the art will appreciate that various changes to the facility may be made without departing from the scope of the invention. For example, project data database 130 and log database 135 are indicated as being contained in a general data store 125. Those skilled in the art will appreciate that the actual implementation of the data store 125 may take a variety of forms, and the term “database” is used herein in the generic sense to refer to any data structure that allows data to be stored and accessed, such as tables, linked lists, arrays, etc.

Those skilled in the art will also appreciate that the facility may be implemented in a variety of environments including a single, monolithic computer system, a distributed system, as well as various other combinations of computer systems or similar devices connected in various ways. Moreover, the facility may utilize third-party services and data to implement all or portions of the information functionality.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A method of displaying a project schedule comprised of a plurality of tasks, the method comprising:
receiving from a user a definition of at least some of a plurality of tasks comprising a project, the received definition for a task comprising a task identifier, a relationship to at least one other of the plurality of tasks, and a range of work associated with the task;
applying a statistical model to estimate an expected task completion date for each of the plurality of tasks having a definition, wherein the statistical model is applied to the range of work associated with a task and the expected task completion date reflects a date within the range of work by which the associated task will likely be completed; and
displaying a graphical representation of the plurality of tasks comprising the project to the user, wherein the graphical representation includes, for each of the plurality of tasks that have a range of work associated with the task, an indication of the range of work associated with each task and the expected task completion date within the range of work.

2. The method of claim 1, wherein the indication of the range of work comprises displaying an earliest start date for the associated task and a latest end date for the associated task.

3. The method of claim 1, further comprising:
calculating an earliest expected end date for each of the plurality of tasks having a definition; and
displaying a graphical representation of the earliest expected end date within the range of work for each of the plurality of tasks.

4. The method of claim 1, further comprising:
calculating a latest expected end date for each of the plurality of tasks having a definition; and
displaying a graphical representation of the latest expected end date within the range of work for each of the plurality of tasks.

5. The method of claim 1, further comprising shading each of the graphical representations of the plurality of tasks comprising the project, wherein a location and degree of shading is selected to correspond to a probability of the associated task being completed.

6. The method of claim 1, further comprising displaying a graphical representation of the applied statistical model on each of the graphical representations of the plurality of tasks comprising the project, wherein the statistical model graphically represents a probability of the associated task being completed.

7. The method of claim 6, wherein the statistical model is one of a normal distribution, a beta distribution, or a log-normal distribution.

8. The method of claim 1, wherein the expected task completion date is identified by an icon.

9. The method of claim 1, wherein the received definition for a task further comprises a promise date for the task, and wherein the graphical representation of the plurality of tasks includes a display of the promise date for each task.

10. A system of displaying a project schedule comprised of a plurality of tasks, the system comprising:
an input module for receiving from a user a definition of at least some of a plurality of tasks comprising a project, the received definition for a task comprising a task identifier, a relationship to at least one other of the plurality of tasks, and a range of work associated with the task;
a task estimation module for applying a statistical model to estimate an expected task completion date for each of the plurality of tasks having a definition, wherein the statistical model is applied to the range of work associated with a task and the expected task completion date reflects a probable date within the range of work by which the associated task should be completed; and
a presentation module for displaying a graphical representation of the plurality of tasks comprising the project to the user, wherein the graphical representation includes, for each of the plurality of tasks that have a range of work associated with the task, an indication of the range of work associated with each task and the expected task completion date within the range of work.

11. The system of claim 10, wherein the indication of the range of work comprises displaying an earliest start date for the associated task and a latest end date for the associated task.

12. The system of claim 10, wherein the task estimation module further calculates an earliest expected end date for each of the plurality of tasks having a definition, and the presentation module displays a graphical representation of the earliest expected end date within the range of work for each of the plurality of tasks.

13. The system of claim 10, wherein the task estimation module further calculates a latest expected end date for each of the plurality of tasks having a definition, and the presentation module displays a graphical representation of the latest expected end date within the range of work for each of the plurality of tasks.

14. The system of claim 10, wherein the presentation module further shades each of the graphical representations of the plurality of tasks comprising the project, wherein a location and degree of shading is selected to correspond to a probability of the associated task being completed.

15. The system of claim 10, wherein the presentation module further displays a graphical representation of the applied statistical model on each of the graphical representations of the plurality of tasks comprising the project, wherein the statistical model graphically represents a probability of the associated task being completed.

16. The system of claim 15, wherein the statistical model is one of a normal distribution, a beta distribution, or a log-normal distribution.

17. The system of claim 10, wherein the expected task completion date is identified by an icon.

18. The system of claim 10, wherein the received definition for a task further comprises a promise date for the task, and wherein the graphical representation of the plurality of tasks includes a display of the promise date for each task.

19. In a project management system, a method of displaying the historical progression of uncertainty in work remaining of a work item, the method comprising:
receiving a first estimate of a range of work remaining for a work item at a first time;
calculating a first expected work remaining for the work item at the first time based at least in part on the first estimate;
receiving a second estimate of a range or work remaining for the work item at a second time;
calculating a second expected work remaining for the work item at the second time based at least in part on the second estimate; and
displaying a graph of the first expected work remaining within the first estimate at the first time and the second expected work remaining within the second estimate at the second time.

20. The method of claim 19, wherein the work item is a task.

21. The method of claim 19, wherein the work item is a project.

22. The method of claim 19, wherein the first expected work remaining and the second expected work remaining is calculated using a statistical model.

23. The method of claim 22, wherein the statistical model is one of a normal distribution, a beta distribution, or a log-normal distribution.

24. The method of claim 19, further comprising:
projecting an expected completion date for the work item based on the calculated first expected work remaining and the calculated second expected work remaining; and
displaying the expected completion date for the work item on the graph.

25. The method of claim 19, wherein the second estimate is automatically calculated based on a rate of work and an elapsed time since the first estimate.

26. A method of displaying the effort remaining for a plurality of sub-items that comprise an item, the method comprising:
receiving from a user a definition of at least some of a plurality of sub-items, the received definition comprising a sub-item identifier, a relationship to at least one other of the plurality of sub-items, and a range of effort associated with the sub-item;
applying a statistical model to estimate an expected remaining effort for each of the plurality of sub-items having a definition, wherein the statistical model is applied to the range of effort associated with a sub-item and the expected remaining effort reflects a probable amount of effort required for completion of the associated sub-item; and
displaying a graphical representation of the plurality of sub-items comprising the item to the user, wherein the graphical representation includes, for each of the plurality of sub-items that have a range of effort associated with the sub-item, an indication of the range of effort associated with each sub-item and the expected remaining effort required for completion of the associated sub-item.

27. The method of claim 26, wherein the item is a project, each of the plurality of sub-items is a task, and further comprising displaying a graphical representation of the expected remaining effort required for completion of the project.

28. The method of claim 26, wherein the item is a group of individuals, each of the plurality of sub-items is an individual to which one or more tasks are assigned, and further comprising displaying a graphical representation of the expected remaining effort required for the group of individuals to complete their assigned tasks.

29. The method of claim 26, wherein the statistical model is one of a normal distribution, a beta distribution, or a log-normal distribution.
